(19) United States
(12) Patent Application Publication
(10) Pub. No.: US 2003/0051388 A1
(43) Pub. Date: Mar. 20, 2003

(54) Fishing rod carrier

(76) Inventors: Bobby D. Barnes, San Antonio, TX (US); Sharon M. Barnes, San Antonio, TX (US)

Correspondence Address: John G. Costa, P.O. Box 948, Highland, NY, 12528, US

(21) Appl. No.: 09/951,593

(22) Filed: Sep. 14, 2001

(51) Int. Cl. A01K 97/10

(52) U.S. Cl. 43/21.2

(57) ABSTRACT

A back mounted, hands-free rod carrier capable of holding and transporting a plurality of rods and reels in a vertical orientation and requiring no support from the arms or hands. The rod carrier can be inexpensively constructed of lightweight pvc pipe segments and is held in place by adjustable nylon straps secured by quick-release fasteners.

### BACKGROUND OF THE INVENTION

1. Field of the Invention

This invention relates to fishing rod carriers and, in particular, to personal, back-mounted, multi-rod carriers.

2. Description of the Related Art

Fishing rods and their associated tackle, including reels, lines, tackle boxes, nets and lures, are awkward and difficult to carry in a safe and convenient manner. The fisherman frequently plies his hobby in isolated and out-of-the-way places and carrying tackle becomes a task that must be accomplished personally, with little or no vehicular assistance or help from others. Further, the fisherman often must negotiate narrow trails, slippery docks and jetties and enter and leave boats, all of which activities are rendered hazardous when carrying fishing tackle. For that reason, it would be advantageous to have a mechanism by which fishing rods and reels could be safely and securely carried, while leaving the hands of the fisherman free to carry other equipment or to assist in negotiating treacherous regions. Moreover, if the rods and reels could be carried in a manner which allows the reels to be attached to the rods, strung and prepared for use, the carrying mechanism so provided would be of particular benefit to the fisherman in that it would allow more time for the actual fishing activity.

The usefulness of fishing rod carriers has not gone unnoticed in the prior art. U.S. Pat. No. 2,854,147, which is a fishing pole rack, discloses a mounted rack for carrying more than one pole. U.S. Pat. No. 2,973,125 is a fishing rod support that is suitable for transporting a single rod and for providing support of that rod while it is in use. U.S. Pat. No. 5,071,048 discloses a fishing rod carrier designed to be hand carried, wherein the rods are carried parallel to the ground at about the position of the knees. U.S. Pat. No. 5,664,721 discloses another carrier designed to carry no more than 2 rods. This carrier uses a pocket to support the butt end of a riffle or fishing rod. U.S. Pat. No. 5,803,519 discloses a rod and reel caddy designed to be hand carried. This carrier is adjustable in length and collapsible when not in use. Like the previous patent, this caddy is designed to be carried low and parallel to the ground. U.S. Pat. No. 5,975,393 discloses a backpack which is designed to carry light and small rods and pieces of tackle.

The carrying equipment described above all suffer from disadvantages that the present invention is specifically designed to eliminate. In particular, rod carriers which must themselves be carried by hand do not provide the benefits of being able to keep one's hands free for support, balance and the ability to hold other items. Rod carriers that hold rods in a position parallel to the ground increase the possibility of rods striking others and becoming entangled in clothing, underbrush and other surrounding objects. Rod carriers that hold one or two rods or that hold only small rods are disadvantageous for the fisherman seeking heavier game or using a variety of different types of tackle.

### SUMMARY OF THE INVENTION

An object of this invention is to provide a rod carrier capable of simultaneously holding and transporting a plurality of rods.

Another object of this invention is to provide a rod carrier capable of holding a plurality of rods, to each of which may be attached a reel and through which may be threaded a fishing line.

A third object of this invention is to provide a rod carrier having the above described characteristics which is light in weight and capable of being quickly and securely strapped onto one's back.

A fourth object of this invention is to provide a rod carrier having the characteristics described above which holds and transports the rods in a vertical, upright position.

A fifth object of this invention is to provide a rod carrier which does not require the use of the hands or arms for its support and which thereby leaves both hands free for other purposes.

A sixth object of this invention is to provide such a rod carrier that is of simple design and which can be constructed of inexpensive and easily obtainable materials.

The above objects are achieved by means of a carrier formed as a rigid frame, of generally trapezoidal shape, which can be constructed of lightweight material, such as, for example, plastic or aluminum. These materials can be used to manufacture a frame as a single piece, such as is the case when the frame is made of molded plastic, or to segmentally assemble a frame, such as is the case when the frame is made from readily obtainable, hollow plastic PVC (polyvinyl chloride) cylindrical pipe pieces. Preferably, said frame is comfortably secured to the back by means of adjustable nylon straps fastened by fast-release clips. Also, preferably, the frame is contoured to rest comfortably on the back of the person carrying the frame. Holding means, used to secure fishing rods or other objects in place, are incorporated into or removably attached to the upper and lower cross braces of the frame. An example of such holding means is the use of small pieces of PVC pipe couplers affixed to the upper and lower cross braces of the frame and oriented to provide a mechanism for holding the rods in a secure, upright position. By way of definition, as used in this invention, the word “incorporated” is used as an adjective to indicate that the object defined by the word is fixed in position and is an integral part of object into which the object defined is incorporated.

The recitation herein of a list of desirable objects which are met by various embodiments of the present invention is not meant to imply or suggest that any or all of these objects are present as essential features, either individually or collectively, in the most general embodiment of the present invention or in any of its more specific embodiments.

### BRIEF DESCRIPTION OF THE FIGURES

FIG. 1 is a schematic drawing of an embodiment of the invention, showing a frame, straps and fasteners and rod holding means.

FIG. 1A is a schematic drawing illustrating a variation in the structure of the embodiment illustrated in FIG. 1,

FIG. 2 is a schematic drawing of another embodiment of the invention.

FIG. 3 is a schematic illustrating the mounting of the invention on the back of a user a manner consistent with its use.

FIG. 4 is a schematic of another embodiment of the invention.

### DESCRIPTION OF PREFERRED EMBODIMENTS

The present invention provides a fishing rod carrier that is capable of securely holding a plurality of fishing rods, together with attached reels and threaded line. Said carrier is suitable for being secured on the back of its user in a manner that maintains the rods in an upright position and allows the hands of the user to be free. Said carrier is lightweight and comfortable, is quickly, easily and securely mountable on the back, is easily and quickly removable, and is inexpensive. Said carrier fits comfortably on the back of a wide range of body types and sizes.

In general the carrier of the invention comprises a frame of generally trapezoidal shape said frame having two elongated sides, an upper cross brace assembly and a lower cross brace assembly; said upper cross brace assembly comprising an upper cross brace and at least one first holding means, said upper cross brace having a right end and a left end, said first holding means being selected from the group consisting of a pair of incorporated vertically aligned portals, an incorporated tubular structure, an incorporated clamp, a removable tubular structure and a removable clamp; said lower cross brace assembly comprising a lower cross brace and at least one second holding means, said lower cross brace having a right end and a left end, said second holding means being selected from the group consisting of a pair of incorporated vertically aligned portals, an incorporated tubular structure, an incorporated clamp, a removable tubular structure and a removable clamp; wherein one said elongated side extends from the left end of said upper cross brace to the left end of said lower cross brace and the other said elongated side extends from the right end of said upper cross brace to the right end of said lower cross brace and wherein at least one first holding means is vertically aligned with at least one second holding means. Preferably the carrier further comprises a set of one or more straps attached to said frame said set of attached straps suitable to enable a person to carry said frame upon a person's back. Note that the portals are holes on the superior and inferior surfaces of the cross braces. The tubular structures may extend above and/or below a cross brace. One or both ends of a tubular structure may be flush with the surface of a cross brace. Thus, the end of a tubular structure may be circular or it may follow the contour of the brace. A difference between a set of portals and a tubular structure is that the portals do not have a cylindrical side.

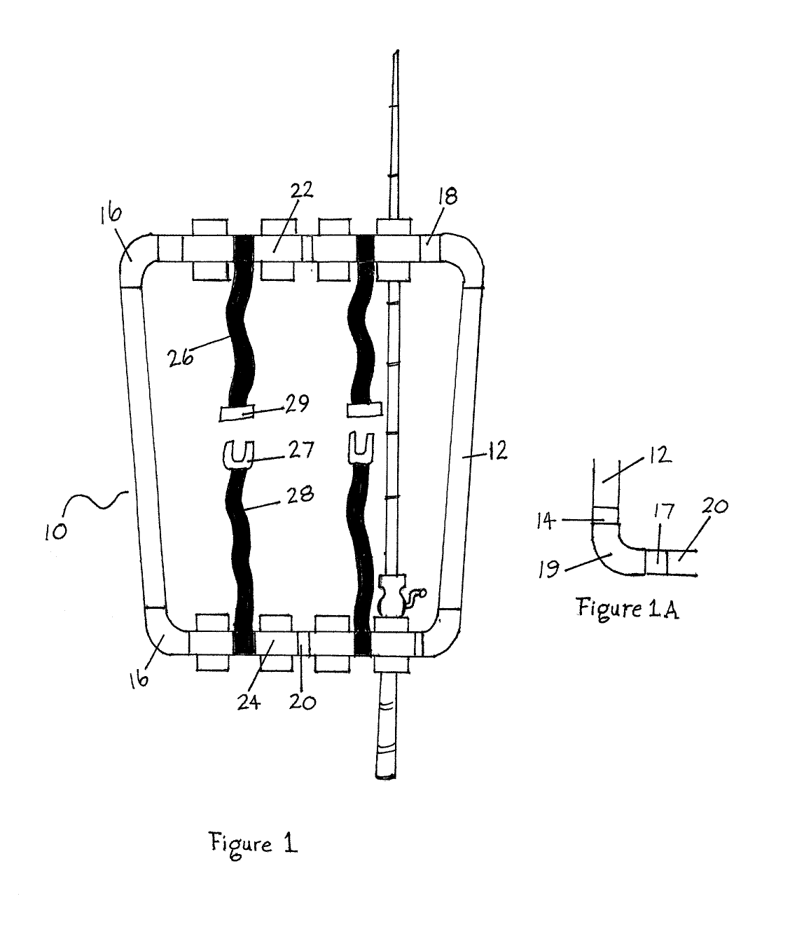

Referring first to FIG. 1, there is shown a schematic drawing of a rod carrier of the invention constructed in accord with a preferred embodiment. The carrier comprises a frame (10), formed of interconnected pipe segments. The two side segments (12) are identical in size and shape, with each segment having a linear portion that is approximately 25 inches long, with short corner segments (16), approximately 5 inches long, on either end, bent at approximately 90 degrees to the linear portion. The side segments (12) may be formed of a single piece of material, such as a length of linear, hollow PVC (polyvinyl chloride) pipe of approximately 1 inch diameter and the short comer segments (16) may be formed by bending a piece of pipe. Alternatively, the comer segments (16) may be formed of separate pieces of PVC pipe and affixed to the linear side segments by elbow couplers or may be only couplers. FIG. 1A shows a short segment (17) attached to another short segment (14) by an elbow coupler (19). An upper end portion (or cross brace) of the frame is formed of a multiple segments of material, such as, for example, hollow PVC piping of 1 inch diameter. Said upper end portion is approximately 29 inches long. A lower end portion (cross brace) of the frame is formed of multiple segments of material, such as, for example, hollow PVC piping of 1 inch diameter and is approximately 20 inches long. Said upper and lower end portions may be attached to said side segments (12) by any of several methods, such as the use of pipe couplers if the material is PVC piping. The upper end piece is constructed of a plurality of hollow segments such as PVC pipe couplers (22) and short sections (18) of PVC pipe. These segments may be arranged as desired by the particular user and for the particular use. The lower end piece (cross brace) is also constructed of a plurality of hollow segments such as PVC pipe couplers (24) and short sections (20) of PVC pipe. Each coupler of the lower cross brace is aligned such that it is vertically below a coupler of the upper cross brace. A pair of nylon adjustable straps, each pair comprising an upper portion (26) and a lower portion (28) is affixed symmetrically to the top and bottom end portions of the frame. Said upper portion (26) terminates in one end (29) of a fast-release clip, whereas said lower portion terminates in the other end (or mate) (27) of a fast-release clip. The overall length of said nylon straps is adjustable.

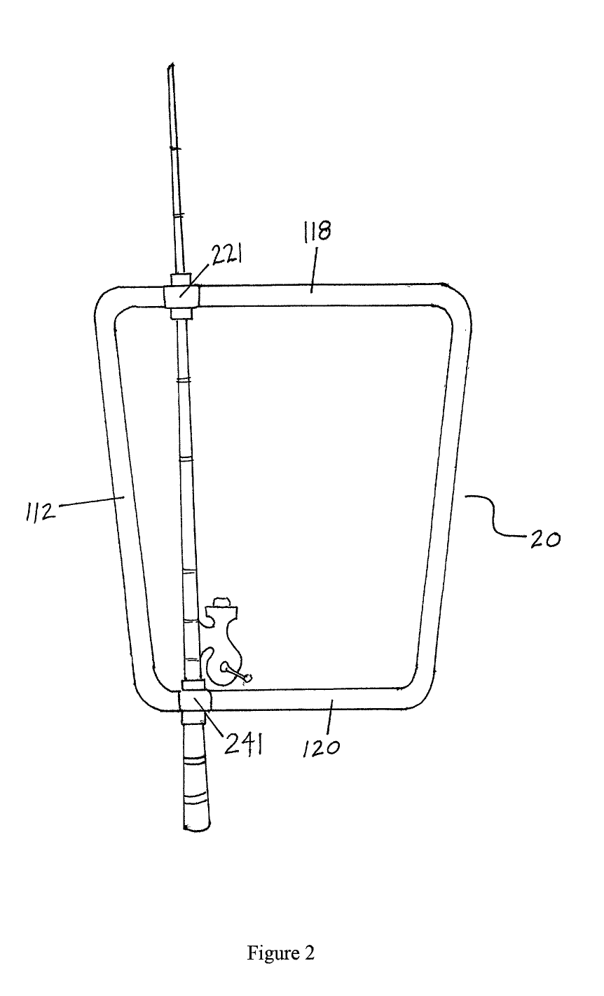

Referring next to FIG. 2, there is shown a schematic drawing of a rod carrier of the invention comprising frame (20) and couplers (221) and (241) wherein a rod and reel are inserted through hollow upper coupler (221) and its corresponding lower coupler (241). The rod and reel are held in place by its weight and by the fact that the reel or a part of the rod handle cannot pass through the lower coupler. The frame in FIG. 2 is made into a continuous loop, such as aluminum or molded plastic and the couplers are removably attached to the frame. The couplers can slide along the frame. This enables a user to change the size of couple to use and the position of the coupler depending on the particular use and needs of the user.

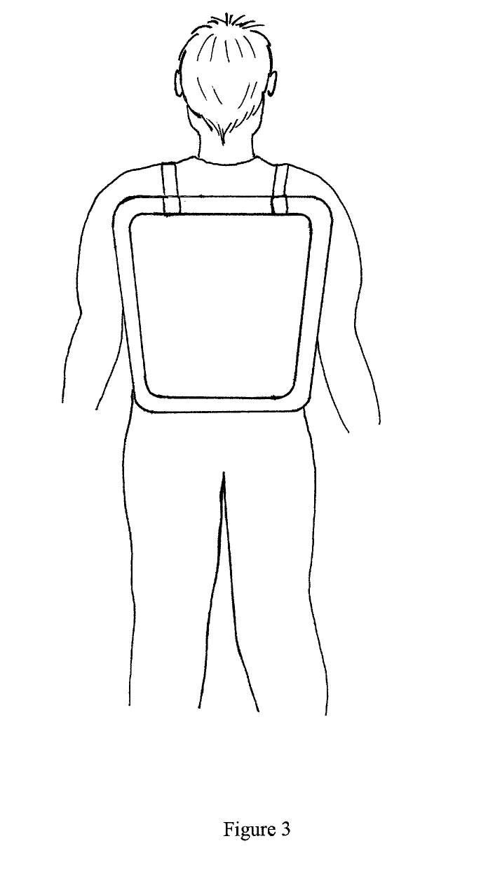

Referring next to FIG. 3, there is shown a schematic drawing of a rod carrier of the invention mounted on the back of a person. Straps are shown at the upper end of the carrier. The other end of the straps can be attached to the lower end of the carrier or to the sides of the carrier. The person's hands are free and not needed to support the rod or the carrier.

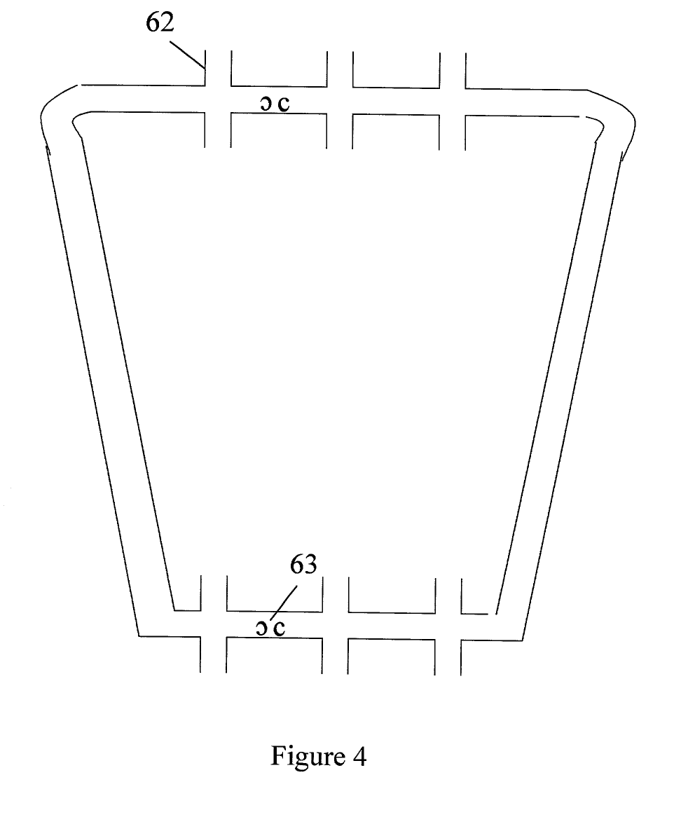

FIG. 4 illustrates a preferred embodiment of the invention in which the carrier is made of molded plastic with tubular vertically aligned structures (62) on the upper and lower cross braces being incorporated into the frame. In addition to the tubular structures, clamps (63) can be affixed to the frame in various positions to permit the carrying of additional rods. A preferred set of measurements for the rod carrier is 25.5 inches across the upper end, 20 inches across the lower end and 26 inches in height.

As is understood by a person skilled in the art, a preferred embodiment of the present invention is illustrative of the present invention rather than being limiting of the present invention. Revisions and modifications may be made to materials, structures, shapes and dimensions through which is formed a back mounted rod carrier, while still providing a back mounted rod carrier, formed in accord with the present invention as defined by the appended claims.

What is claimed is:

1. A carrier comprising:
a frame of generally trapezoidal shape said frame having two elongated sides, an upper cross brace and a lower cross brace, each cross brace having a right end and a left end, wherein one said elongated side extends from the left end of said upper cross brace to the left end of said lower cross brace and the other said elongated side extends from the right end of said upper cross brace to the right end of said lower cross brace, wherein one or more tubular structures are incorporated in each said cross brace, each said incorporated tubular structure of one cross brace being vertically aligned with one incorporated tubular structure of the other cross brace.

2. The carrier of claim 1 further comprising one or more clamps incorporated in each said cross brace, each said incorporated clamp of one cross brace being vertically aligned with one incorporated clamp of the other cross brace.

3. The carrier of claim 1 further comprising one or more removable clamps said removable clamps being removably attachable to at least one said cross brace.

4. The carrier of claim 1 further comprising one or more removable tubular structures said removable tubular structure being removably attachable to at least one said cross brace.

5. A carrier comprising:
a frame of generally trapezoidal shape said frame having two elongated sides, an upper cross brace and a lower cross brace, each cross brace having a right end and a left end, wherein one said elongated side extends from the left end of said upper cross brace to the left end of said lower cross brace and the other said elongated side extends from the right end of said upper cross brace to the right end of said lower cross brace, wherein one or more pairs of vertically aligned portals are incorporated in each said cross brace, each said pair of portals of one cross brace being vertically aligned with one pair of portals of the other cross brace.

6. The carrier of claim 5 further comprising one or more clamps incorporated in each said cross brace, each said incorporated clamp of one cross brace being vertically aligned with one incorporated clamp of the other cross brace.

7. The carrier of claim 5 further comprising one or more removable clamps said removable clamps being removably attachable to at least one said cross brace.

8. The carrier of claim 5 further comprising one or more tubular structures incorporated in each said cross brace, each said incorporated tubular structure of one cross brace being vertically aligned with one incorporated tubular structure of the other cross brace.

9. The carrier of claim 5 further comprising one or more removable tubular structures said removable tubular structure being removably attachable to at least one said cross brace.

10. A carrier comprising:
a frame of generally trapezoidal shape said frame having two elongated sides, an upper cross brace and a lower cross brace, each cross brace having a right end and a left end, wherein one said elongated side extends from the left end of said upper cross brace to the left end of said lower cross brace and the other said elongated side extends from the right end of said upper cross brace to the right end of said lower cross brace, wherein one or more clamps are incorporated in each said cross brace, each said incorporated clamp of one cross brace being vertically aligned with one incorporated clamp of the other cross brace.

11. The carrier of claim 10 further comprising one or more removable clamps said removable clamps being removably attachable to at least one said cross brace.

12. The carrier of claim 10 further comprising one or more removable tubular structures said removable tubular structure being removably attachable to at least one said cross brace.

13. A carrier comprising:
a frame of generally trapezoidal shape said frame having two elongated sides, an upper cross brace and a lower cross brace, each cross brace having a right end and a left end, wherein one said elongated side extends from the left end of said upper cross brace to the left end of said lower cross brace and the other said elongated side extends from the right end of said upper cross brace to the right end of said lower cross brace, wherein one or more tubular structures are removably attached to at least one said cross brace.

14. A carrier comprising:
a frame of generally trapezoidal shape said frame having two elongated sides, an upper cross brace and a lower cross brace, each cross brace having a right end and a left end, wherein one said elongated side extends from the left end of said upper cross brace to the left end of said lower cross brace and the other said elongated side extends from the right end of said upper cross brace to the right end of said lower cross brace, wherein one or more clamps are removably attached to at least one said cross brace.

15. A carrier comprising: a frame of generally trapezoidal shape said frame having two elongated sides, an upper cross brace assembly and a lower cross brace assembly; said upper cross brace assembly comprising an upper cross brace and at least one first holding means, said upper cross brace having a right end and a left end, said first holding means being selected from the group consisting of a pair of incorporated vertically aligned portals, an incorporated tubular structure, an incorporated clamp, a removable tubular structure and a removable clamp; said lower cross brace assembly comprising a lower cross brace and at least one second holding means, said lower cross brace having a right end and a left end, said second holding means being selected from the group consisting of a pair of incorporated vertically aligned portals, an incorporated tubular structure, an incorporated clamp, a removable tubular structure and a removable clamp; wherein one said elongated side extends from the left end of said upper cross brace to the left end of said lower cross brace and the other said elongated side extends from the right end of said upper cross brace to the right end of said lower cross brace and wherein at least one first holding means is vertically aligned with at least one second holding means.

16. The carrier of claim 15 further comprising a set of one or more straps attached to said frame said set of attached straps suitable to enable a person to carry said frame upon a person's back.

17. The carrier of claim 15 wherein said frame is manufactured as a single piece of material.

18. The carrier of claim 15 wherein said frame is a single piece of molded plastic.

19. The carrier of claim 15 wherein said frame is assembled from multiple pieces of material.

20. The carrier of claim 15 wherein said frame is assembled from multiple pieces of PVC pipe.
